(19) United States
(12) Patent Application Publication
(10) Pub. No.: US 2025/0378542 A1
(43) Pub. Date: Dec. 11, 2025

(54) METHOD AND APPARATUS FOR RECOGNIZING AND DIAGNOSING DEFECTS IN STATIONARY OBJECTS WHILE TRAVELING USING A MOBILE UNIT

(71) Applicant: Neural D Inc., Chungcheongbuk-do (KR)

(72) Inventor: Ji Ho Kwak, Gyeonggi-do (KR)

(73) Assignee: Neural D Inc., Chungcheongbuk-do (KR)

(21) Appl. No.: 18/738,059

(22) Filed: Jun. 10, 2024

(51) Int. Cl. G06T 7/00; G01N 21/88; G01N 25/72; G06V 10/82; G06V 20/50

(52) U.S. Cl. CPC G06T 7/0002; G01N 21/8851; G01N 25/72; G06V 10/82; G06V 20/50; G06T 2207/10048; G06T 2207/20081; G06T 2207/20084; G06T 2207/30252

(57) ABSTRACT

Provided are a method and apparatus for dynamically recognizing and diagnosing defects in stationary objects using a monitor device while traveling using a mobile unit, where the monitor device is mounted on the mobile unit through a pan tilt adjust mount. The method may include continuously capturing images of a predetermined area using a first camera included in the monitor unit, detecting a target stationary object to diagnose among objects in the captured image, capturing a high-quality image and a thermal image of the detected target stationary object using a second camera and a thermal camera included in the monitor unit, determining whether the detected target stationary object has defects based on the high-quality image and the thermal image, and transmitting a result of determination to a predetermined device.

### BACKGROUND

The present disclosure relates to a method and apparatus for dynamically recognizing and diagnosing defects in stationary objects while traveling using a mobile unit.

In related arts, a vehicle has been utilized to monitor and evaluate the statues of stationary target objects, such as utility poles and electric wires. For example, a vehicle is equipped with a monitor device including at least one camera and driven along a predetermined path (e.g., route) in a target area. While the vehicle is in motion, the monitor device continuously captures images of stationary target objects, analyzes the captures images, and detects defects of the stationary target object based on the analysis result. However, it becomes increasingly difficult for accurately and efficiently detect such defects, especially as the speed of the vehicle increases and the stationary target objects appear more frequently.

### SUMMARY

In accordance with an aspect of the present embodiment, a method and apparatus may be provided for dynamically recognizing and diagnosing defects in stationary objects in real time while traveling using a mobile unit.

In accordance with another aspect of the present embodiment, a method and apparatus may be provided for automatically adjusting a focusing direction and a focusing angle of a monitor device including focusing camera to ensure that the target stationary object is centered in the images captured by the focusing camera, navigation camera, and thermal imaging camera.

In accordance with another aspect of the preset embodiment, a method and apparatus may be provided for utilizing a thermal image of a target stationary object with an appearance image thereof to recognize a target stationary object and to determine the defects in the target stationary object.

In accordance with still another aspect of the present embodiment, a method and apparatus for determining a pixel group of thermal distribution based on a distance and a wind speed, to be used for analyzing the defects of the stationary target object.

In accordance with yet another aspect of the present embodiment, a method and apparatus may be provided for accurately and effectively reading and measuring defects of the target object using a Virtual Guide Box. In particular, the method may use i) a virtual central cross reference line and ii) a virtual central guide box.

In accordance with yet another aspect of the present embodiment, a method and apparatus may be provided for differently processing of target area images and target object images according to changes in various target areas, thereby accurately and effectively reading defects of the target object. For example, methods include i) image recognition processing according to lane changes (from one lane to two lanes or from two lanes to one lane), ii) image recognition processing for curved roads, iii) image recognition processing when exiting the recognition range, and iv) effective image recognition methods when a moving object makes left/right turns or U-turns.

In accordance with yet another aspect of the present embodiment, a method and apparatus may be provided measuring the vehicle's speed using GPS and varying the filming of the target object according to the travel speed.

In accordance with yet another aspect of the present embodiment, a method and apparatus may be provided for measuring the coordinates of the target object while in motion.

In accordance with yet another aspect of the present embodiment, a method and apparatus may be provided for effectively and accurately detecting defects of the target object by training the captured images through AI deep learning by superimposing a thermal image screen on a real image.

In accordance with yet another aspect of the present embodiment, a method and apparatus may be provided for filming a target area and setting the range of operation of the camera or the recognition range of the target object according to the shape of the filmed area. For example, after recognizing the shape of the area by the camera's focus angle such as medium or high angle, it applies different algorithms for recognizing the target object according to the recognized shape of the area. The recognized shapes of the areas include alleys, two-lane, four to ten-lane roads.

### BRIEF DESCRIPTION OF THE DRAWINGS

FIG. 1 is a diagram illustrating a system for dynamically recognizing and diagnosing defects in stationary objects while traveling using a mobile unit in accordance with an embodiment.

FIG. 2 illustrates a monitor device and a pan tilt adjust mount in accordance with an embodiment.

FIG. 3 is a block diagram illustrating a monitor device in accordance with an embodiment.

FIGS. 4A, 4B, and 4C are flowchart illustrating a method of dynamically recognizing and diagnosing defects in stationary objects while traveling using a mobile unit in accordance with an embodiment.

FIG. 5 is a flowchart describing the method for adjusting to center the target object in the captured image.

FIG. 6 is a drawing to explain the virtual guide box and virtual recognition box.

FIG. 7 illustrates how the virtual recognition box enters the virtual guide box.

FIG. 8 shows an image captured by the second camera of the monitor device, capturing the target in high quality within the virtual recognition box.

FIG. 9 is a drawing explaining the operation of recognizing each component of the target detected in high quality.

FIGS. 10A and 10B are flowcharts related to accurately measuring the GPS coordinates of the target object using GPS signals.

FIGS. 11A, 11B, and 11C are drawings explaining the process of calculating the GPS coordinates.

FIGS. 12A and 12B are drawings explaining how to find defects in the appearance of the target from high-quality images captured of the target.

FIG. 13 is a drawing explaining an example of applying thermal image distribution differently based on distance.

FIGS. 14A and 14B show images captured using a thermal camera

FIG. 15 is a drawing explaining a method for efficiently conducting shooting modes using the sector clock position method.

FIGS. 16A, 16B, 16C, and 16D illustrate a method for detecting lane changes.

### DETAILED DESCRIPTION OF EMBODIMENTS

The present disclosure relates to a device and method for capturing images of stationary objects while moving at high speeds, analyzing the captured images, assessing the condition of the objects, identifying defects based on the analyzed results, and reporting the detected defects in real-time.

Specifically, the device and method of the present disclosure perform the following operations.

First, the monitor device is adjusted to position the stationary target object at the center of the image.

Second, using a Virtual Guide Box and a virtual recognition box, the target object is accurately and effectively read.

Third, in forward recognition, high-quality images and thermal images of detected objects are used to effectively detect the target objects.

Fourth, the GPS coordinates of the detected objects are accurately calculated considering environmental factors of the shooting.

Fifth, using high-quality and thermal images of the detected objects, defects are effectively detected.

Sixth, the sector clock position method is used to detect the shooting mode and perform efficient operations according to each mode.

Seventh, by comparing the direction of the mobile unit with the progression direction of the detected target, changes in the shooting environment are detected, and an appropriate shooting mode is applied to conduct efficient operations.

Eighth, a stop event during operation is detected, and upon detection, all operations are temporarily halted or paused until a resume event occurs, efficiently utilizing the shooting resources.

Hereinafter, an apparatus for dynamically recognizing and diagnosing defects in stationary objects while traveling using a mobile unit will be described with reference to the accompanying drawings.

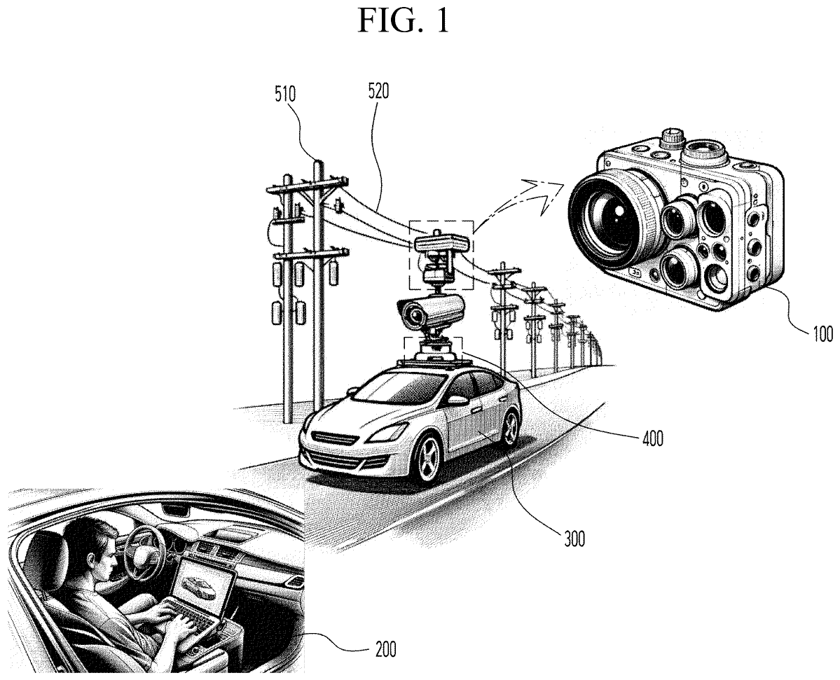

FIG. 1 is a diagram for illustrating an apparatus for recognizing and diagnosing defects in stationary objects while traveling using a mobile unit in accordance with an embodiment.

Referring to FIG. 1, the apparatus for recognizing and diagnosing defects in stationary objects while traveling using a mobile unit may include monitor device 100, control device 200, mobile unit 300, and pan tilt adjust mount 400 in accordance with an embodiment. In particular, monitor device 100 may be mounted on mobile unit 300 through pan tilt adjust mount 400. Such apparatus may be referred to as a mobile integrated scan diagnostic system. However, the embodiments of the present discourse are not limited thereto. Any similar term may be used.

Monitor device 100 may be mounted on Mobile unit 300 through pan tilt adjust mount 400 and travel along a predetermined route in accordance with an embodiment.

While traveling, monitor device 100 may photograph a predetermined area, search target stationary objects in captured images of the predetermined area, the detected target stationary objects

That is, mobile unit 300 moves monitor device 200 along a predetermined route, allowing the monitor device 100 to automatically and continuously capture images of target stationary objects in specific areas.

Mobile unit 300 may be driven along the predetermined route by a driver. However, the embodiments are not limited thereto. For example, mobile unit 300 may be remotely controlled by an operator located at a specific place. Alternatively, mobile unit 300 may be remotely controlled by a computer to operate along the predetermined route.

Mobile unit 300 may refer to any type of device or equipment that has the capability to move from one location to another. This term is quite broad and may encompass a variety of different technologies and applications.

Mobile unit 300 may include i) vehicles: such as cars, trucks, motorcycles, and bicycles, which are traditional means of transport, ii) mobile machinery: like construction equipment (e.g., cranes and bulldozers) that can be moved to various worksites, iii) robotics: includes autonomous or remotely operated robots that can navigate different environments, iv) unmanned vehicle that operates without a human driver, typically controlled remotely or autonomously, and v) drone, which is an aircraft that operates without a human pilot on boards. Drone may be remotely controlled by a human operator or operate autonomously based on pre-programmed flight plans or more complex dynamic automation system.

However, the embodiments are not limited to the term “mobile unit.” The defining characteristic of a mobile unit is its ability to be moved or transported, providing flexibility and functionality across different settings and scenarios.

The target stationary objects may be utility poles 510 or electric lines 520, but also tunnels, bridges, pipelines, landslide areas, retaining walls, rocks, dams, etc.

As described, monitor device 100 may be mounted on mobile unit 300 through pan tilt adjust mount 400 and connected to control device 200 through a communication line or wirelessly. Monitor device 100 may continuously capture images predetermined areas, collect predetermined data including GPS signal, temperature, distance to a target area, and provide the captured images with the collected data to control device 200. Monitor device 100 may be controlled by control device 200 to accurately capture an image of a target stationary object in high quality in accordance with an embodiment.

For example, control unit 200 may analyze and recognize target stationary objects in the captured images and may pan and tilt monitor device 100 by controlling pan tilt adjust mount 400 based on the analyzing and recognizing results.

Monitor device 100 may be attachable/detachable to/from mobile unit 300 in accordance with an embodiment.

Control device 200 may be connected to monitor device 100, receive images of target areas, detect a target object in the image, and pan and tilt monitor device 100 based on the detecting result.

Control device 200 may detect defects of the target object based on the images of the target object and automatically generate a report thereof.

Control device 200 may be a computing system with a display, such as a laptop computer.

Control device 200 may be connected to monitor device 100 through a communication line or wireless through a radio signal link. Accordingly, control device 200 may be located at a remote location and remotely control monitor device 100 in distance.

Monitor device 100 and control device 200 may capture continuous images of stationary target object such as utility poles 510 and electric wires 520 while mobile unit 300 is in motion. Control device 200 may quickly control tilting and panning of monitor device 100 to ensure the target object is centered in an image.

Control device 200 may be connected to monitor device 100, receive various types of data from monitor device 100, analyze the received data, and determine whether a target stationary object has defects in accordance with an embodiment.

In accordance with an embodiment, control device 200 collects data from monitor device 100 and learns from the shapes of target stationary objects. If a fixed structure is detected in the images provided by the camera, the tracking control unit controls the angle adjustment of the pan-tilt to ensure the fixed structure is centered in the images for diagnosis.

Control device 200 analyzes the appearance of the fixed structure from the camera images to determine if the condition is normal and analyzes the thermal distribution from the thermal images to make a secondary determination of the condition. These analyses are combined to diagnose the condition of the fixed structure.

This invention enables the rapid and accurate imaging and high-quality diagnostic performance of continuously appearing multiple fixed structures by ensuring that they are automatically detected, tracked, and centered in the images captured by the camera and thermal imaging camera.

Control device 200 may be implemented as an independent device using a computing system including a display as shown in FIG. 1. However, the embodiments are not limited thereto. For example, control device 200 may be integrated and embedded within monitor device 100 as one device.

Control device 200 may include at least one processor and memories for controlling monitor device 100, tracking the target stationary objects, gathering information measured and collected from monitor device 100, analyzing the gathered information, and determining defects of the target stationary objects in accordance with an embodiment.

Furthermore, control device 200 may include at least one processor and memories for performing a deep learning operation for image recognition of target station objects and defects thereof by accumulating the collected data and recognize patterns thereof using artificial intelligence (AI) to build an “artificial neural network” thereof to make intelligent decision.

Control device 200 also calculates the exact coordinates of the target stationary object based on the corrected vehicle coordinates, the distance measured by the laser rangefinder, and the azimuth detected by the azimuth sensor.

For example, the stationary target object may include power facilities such as utility poles, tunnels, bridges, pipelines, landslide areas, retaining walls, rocks, and dams.

In this specification, monitor device, control device, and, mobile unit are described as being conFIG.d as separate devices, but this does not limit the embodiments. For example, monitor device and control device may be implemented as a single device. In this case it may be designed to monitor and control in conjunction with a smartphone or tablet. Additionally, it can be also be conFIG.d as a single device included in the mobile unit. In this case, the monitor device and control device may be included in an autonomous vehicle or an autonomous drone.

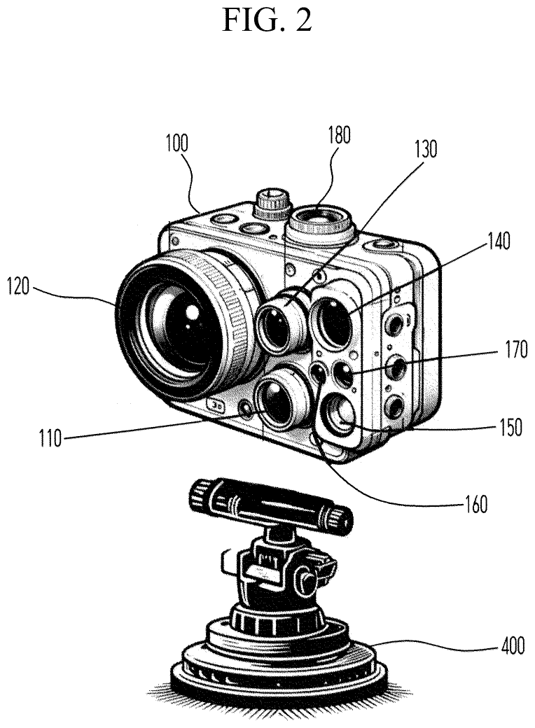

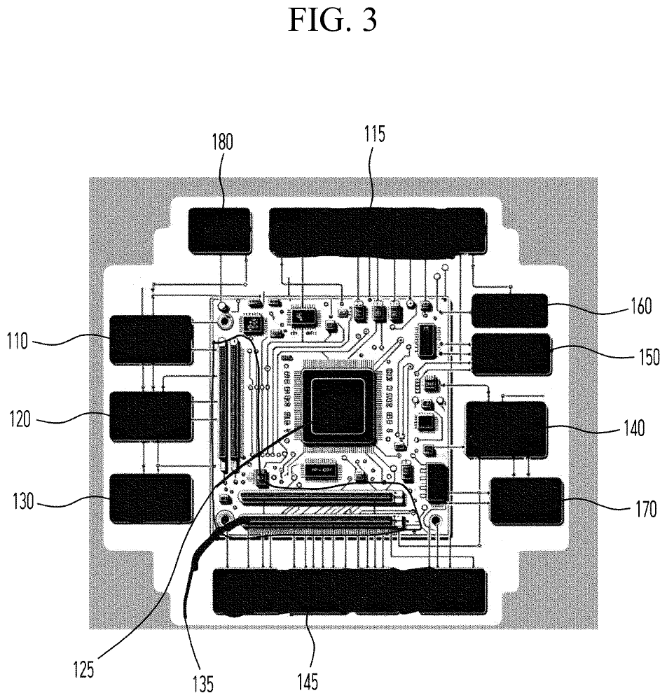

Hereinafter, monitor device 100 will be described in more detail with reference to FIG. 2 and FIG. 3.

FIG. 2 illustrates a monitor device and a pan tilt adjust mount in accordance with an embodiment.

Referring to FIG. 2, monitor device 100 may include first camera 110, second camera 120, thermal camera 130, laser rangefinder 140, azimuth sensor 150, wind speed meter 160, speed meter 170, and GPS receiver 180 in accordance with an embodiment. However, the embodiments are not limited thereto. FIG. 2 only shows one of exemplary monitor devices and it's essential parts. For example, in another embodiments, monitor device may be conFIG.d with

First camera 110, also known as the Navigation camera 110, is a digital camera capable of capturing images with a resolution of at least 1 megapixel. The first camera 110 continuously captures images of a predetermined area in front.

Second camera 120, also referred to as the Focusing camera 120, is a high-quality image camera that captures target objects in high quality. This camera captures and stores images of the infrastructure's exterior and is a digital camera capable of capturing images with a resolution of 50 megapixels or more.

Images captured by the first camera 110 are analyzed to detect the presence of target objects within these images. If a target object is detected, it is then recaptured in high quality using the second camera 120. The high-quality images captured by the second camera 120 are used to assess defects in the target objects.

Thermal camera 130, used in conjunction with the first camera 110, captures thermal images of the predetermined area to detect target objects. Thermal camera 130, along with second camera 120, captures the thermal distribution of detected target objects using the temperature data from the thermal distribution to detect defects. The thermal camera 130 is capable of capturing thermal images with a resolution of at least 320×420.

Images captured by the first camera 110, second camera 120, and thermal camera 130 are used to develop specific models using AI deep learning techniques, which are then used to detect target objects, such as utility poles, electric wires, or distribution equipment.

Particularly, Convolutional Neural Networks (CNNs) are utilized to automatically learn features from images, allowing for the recognition, classification, and analysis of target objects.

Laser rangefinder 140 calculates distance by emitting a laser beam towards the target object and measuring the time it takes for the beam to hit the target and reflect back.

Azimuth sensor 150 measures the absolute direction or position of the monitor device 100 based on Earth's magnetic field.

Wind speed meter 160 measures the speed or force of the wind and may also be referred to as an anemometer.

Speedometer 170 measures the speed of the mobile unit 300 or other moving objects.

Laser rangefinder 140, azimuth sensor 150, windspeed meter 160, speedometer 170 may measure a distance to a target object, azimuth angle, wind speed, and a driving speed while operating, providing data to control device 200 for various purposes.

GPS receiver 180 receives GPS data from satellites or RTK correction data from at a predetermined base station based on the received GPS data to calculate accurate coordinates.

The pan tilt adjust mount 400 is designed to adjust the shooting direction of the monitor device 100. Specifically, the pan tilt adjust mount 400 is engineered to be attachable and detachable to the mobile unit 300, as well as to the monitor device 100 itself. The pan tilt adjust mount 400 allows the monitor device 100 to be moved up, down, left, and right by adjustments made via the control device 200, enabling the adjustment of the shooting angle in upward, downward, leftward, and rightward directions.

FIG. 3 is a block diagram illustrating a monitor device in accordance with an embodiment.

Referring to FIG. 3, monitor device 100 may include first camera 110, second camera 120, thermal camera 130, laser rangefinder 140, azimuth sensor 150, wind speed meter 160, speedometer 170, GPS receiver 180, communication circuit 115, central processing unit (CPU) 125, memory 135, and pan tilt adjust mount connector 145. Since first camera 110, second camera 120, thermal camera 130, laser rangefinder 140, azimuth sensor 150, wind speed meter 160, speedometer 170, GPS receiver 180 were already described with reference to FIG. 2, communication circuit 115, central processing unit (CPU) 125, memory 135, and pan tilt adjust mount connector 145 will be described hereinafter.

The Communication Circuit 115 is an electronic circuit that performs the function of transmitting and receiving data. This circuit facilitates the exchange of signals within a device or between devices and supports various communication technologies including wired networks, wireless networks, and internet connections. For example, it is an essential component for ensuring smooth data communication in mobile devices or remote control systems.

The Central Processing Unit (CPU) 125 serves as the “brain” of the digital device and is the main processing unit. It performs all types of data processing tasks, interpreting and executing instructions to manage all operations and control of the device. It receives, processes, and adjusts information from all components of the device. In FIG. 3, it is assumed that the control device 200 and the monitor device 100 are integrated into one unit. Therefore, the CPU 125 coordinates all components, analyzes the input information and images, detects defects in the target object, and can transmit the results to external devices via the communication circuit 115. In this case, the defect detection results can be sent to the relevant personnel's smartphone, computer, tablet, etc.

Memory 135 stores data and instructions, supplying them to the CPU, and then stores the data processed by the CPU.

Pan Tilt Adjust Mount Connector 145 is a connection part that allows the monitor device 100 to be attached to or detached from the pan tilt adjust mount 400.

Further, monitor device 100 may be wirelessly connected to an external device, such as a smartphone, a tablet or a laptop computer for reporting the defects of the target stationary object or status of operating monitor device 100.

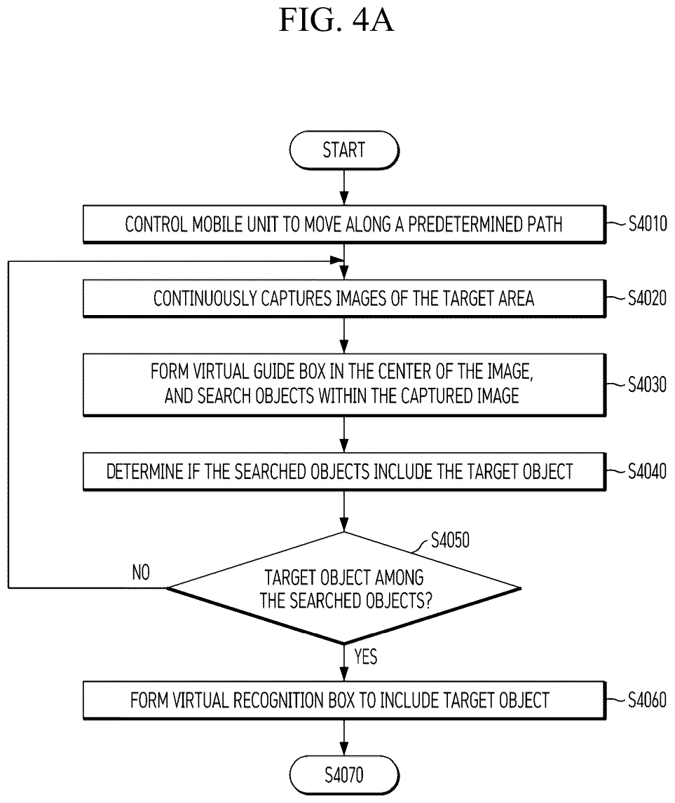

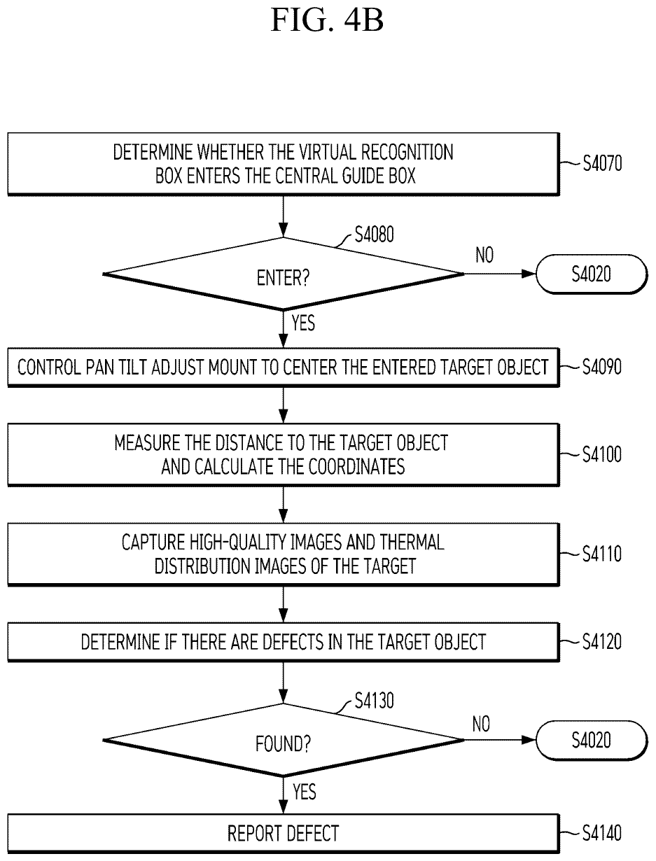

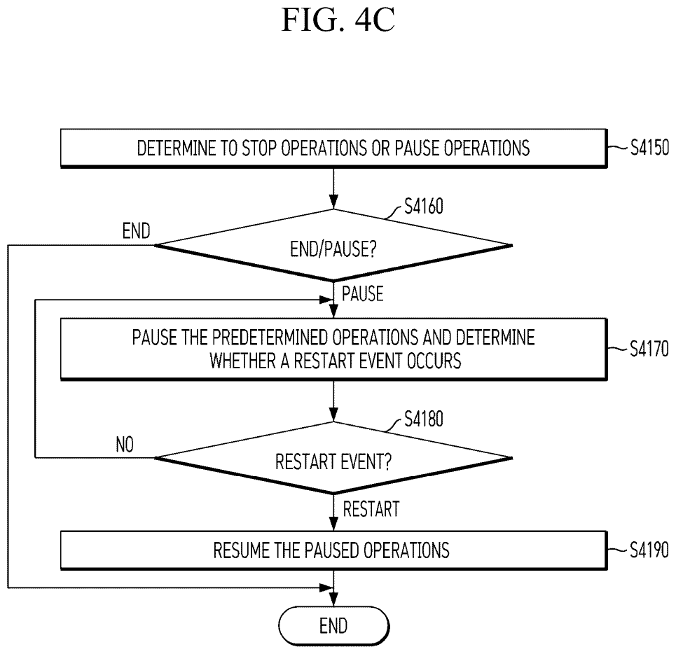

Hereinafter, a method for dynamically recognizing and diagnosing defects in stationary objects while traveling using a mobile unit in accordance with an embodiment will be described with reference to FIG. 4A to FIG. 20.

FIGS. 4A, 4B, and 4C are flowchart illustrating a method for dynamically recognizing and diagnosing defects in stationary objects in real time while traveling using a mobile unit in accordance with an embodiment.

Referring to FIGS. 4A, 4B, and 4C, the method for dynamically recognizing and diagnosing defects in stationary objects will be performed as follows.

At step S4010, the mobile unit 300 is controlled to move along a predetermined path.

The mobile unit 300 may be a typical automobile or an Unmanned Vehicle (UMV). In the case of a typical automobile, it is operated by a driver onboard. In the case of an Unmanned Vehicle (UMV), it can be remotely controlled from a remote location. Alternatively, it may automatically move along a predetermined path programmed into it.

At step S4020, while the mobile unit 300 moves along the predetermined path, the monitor device 100 continuously captures images of the target area.

For this purpose, the first camera 110 and the thermal camera 130 are used to continuously capture images of the target area.

The captured images are transmitted to the control device 200 for analysis.

Alternatively, if the control device 200 is integrated with the monitor device 100, the monitor device 100 analyzes the captured footage. This specification describes the analysis being performed by the monitor device 100.

In addition to images, data for analysis is also collected. For example, azimuth, wind speed, velocity, and GPS information are continuously measured or collected.

At step S4030, a virtual guide box is formed in the center of the captured image, and objects within the captured image are searched.

Object search within the captured image utilizes deep learning technology, employing a model created from previously accumulated images to search for the desired objects, which in this case are utility poles or power lines.

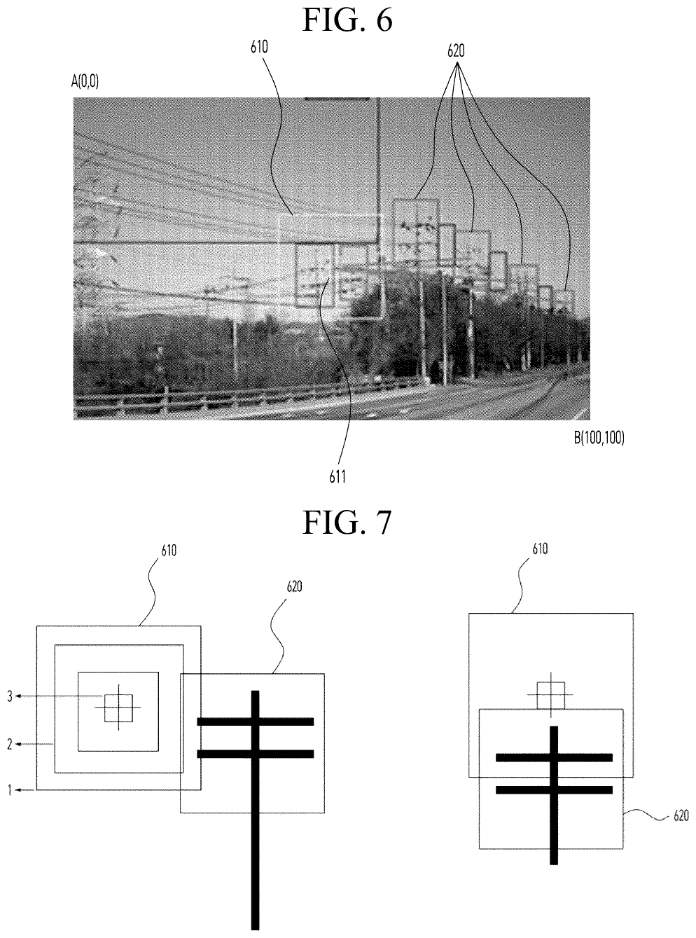

The virtual guide box 610 is formed as a rectangle of a fixed size at the center, as depicted in FIGS. 6 and 7. The shape and size of the virtual guide box can vary and be adapted to the surrounding environment and specific conditions, which will be detailed further when describing FIGS. 6 and 7.

Virtual guide box 610 includes a central point 611 and remains centered in the captured image, regardless of the direction of travel of the mobile unit 300.

The size and shape of the virtual guide box 610 may vary depending on the shooting mode or the speed of travel. a. For example, in a non-alley mode at a speed of 20-30 km/h, the guide box might be a standard square of 1 cm by 1 cm. b. In alley mode, where the mobile unit 300 moves slowly (due to narrow paths, speed limits, safety concerns, etc.), and objects appear irregularly crossing from left to right based on the 12 o'clock position, the guide box might be set smaller (0.5 cm square), or as a tall rectangle (0.5×1 cm), or even in an inverted triangle shape. c. In high-speed travel mode, where the speed exceeds 30 km/h, the guide box is made larger, for example, 2×2 cm.

At step S4040, determine if the searched objects include the target object for capture.

Specifically, decide whether there is a target object for capture, such as a utility pole, among the searched objects.

At step S4050, if the target object for capture is present among the searched objects?

If there is no target object (No—S4050), return to step S4020 and continuously shoot the designated area using the primary camera.

If the target object for capture is present (Yes—S4050), proceed to step S4060.

At step SS4060, a virtual recognition box may be formed to include the searched target object for capture.

As depicted in FIGS. 6 and 7, a virtual recognition box 620 is formed to include the searched target object.

Since multiple target objects for capture can be included in a single image, multiple virtual recognition boxes 620 are formed, as shown in FIG. 6.

The formed virtual recognition boxes move from left to right or right to left, from bottom to top, or top to bottom, depending on the direction of travel (travel direction) of the mobile unit 300.

At step S4070, whether the virtual recognition box 620 containing the searched target object enters the central guide box may be determined 610.

If it does not enter (No—S4080), continue capturing images by proceeding to step S4020.

If it enters (Yes—S4080), the pan tilt adjust mount 400 may be adjusted to center the entered target object in the captured image at step S4090.

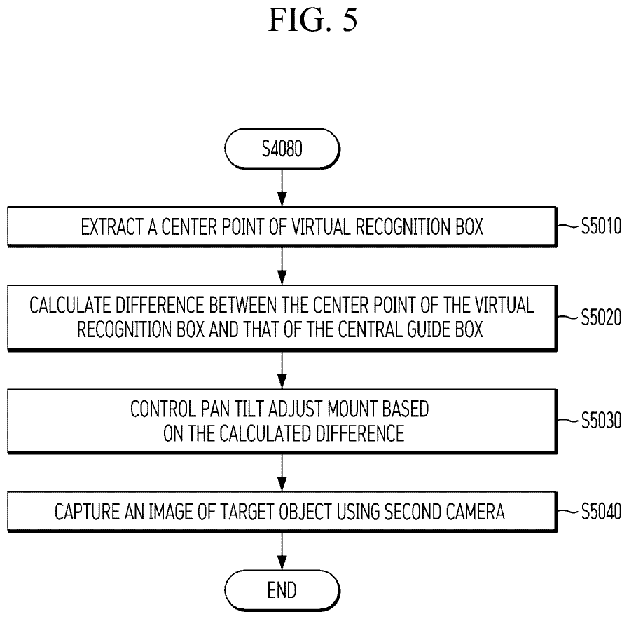

Such operation S4090 will be described in more detail in FIG. 5. That is, adjusting operation (S4090) may be performed as follows.

a. extract the center point (x, y) of the virtual recognition box containing the entered target object.

b. Calculate the difference between the center point (x, y) of the virtual recognition box and the center point (Cx, Cy) of the central guide box.

c. Based on the calculated difference, adjust the pan tilt adjust mount 400 so that the center point of the virtual recognition box aligns with the center point of the central guide box.

At step S4100, the distance to the target object included in the virtual recognition box may be measured and the coordinates of the target object may be computed.

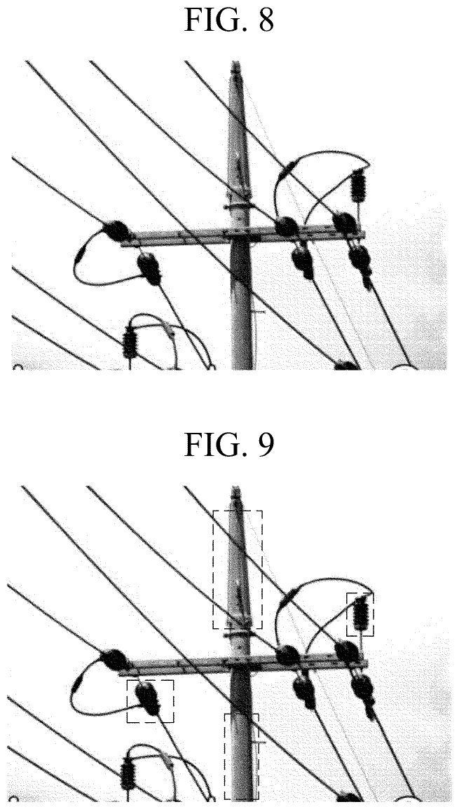

That is, operation S4100 will be described in more detail in FIG. 8 later.

At step S4110, high-quality images and thermal distribution images of the target may be obtained using the thermal camera and the second camera. In addition to images, other data are also measured, and collected. For example, using the speed meter 170, wind speed meter 160, and azimuth sensor 150, data on the vehicle's speed, wind speed, and azimuth are collected.

At step S4120, using the captured images, thermal distribution, and collected data, it is determined if there are defects in the target object.

If no defects are found (No—S4130), return to step S4020 and continue capturing images.

If a defect is found (Yes—S4130), the collected information and captured images may be used to report the defect in step S4140.

At step S4150, it is determined whether a command to stop operations has been received, or if an event to temporarily pause operations has occurred.

If neither a stop command nor a pause event has occurred (No-S4160), proceed to S4020 to continue capturing images.

If a pause event occurs (Pause S4160), the predetermined operations may be paused, and it is determined whether a restart event occurs at step S4170.

In accordance with an embodiment, pause events include sudden lane changes or turns. Resume events occur when there are no sudden lane changes or turns, and after a certain period has elapsed.

If a restart event occurs (Yes—S4180), the paused operations may be resumed at step S4190.

If not a restart event (No—S4180), proceed again to S4170.

If a termination command is received (End—S4160), all operations may be terminated.

From this point on, the operation of S4090, which involves adjusting the shooting direction of monitor device 100 via the pan tilt adjust mount 400 to center the detected target object in the captured image, will be described using FIGS. 5, 6, and 7.

FIG. 5 is a flowchart describing the method for adjusting to center the target object in the captured image. FIG. 6 is a drawing to explain the virtual guide box and virtual recognition box. FIG. 7 illustrates how the virtual recognition box enters the virtual guide box.

FIG. 8 shows an image captured by the second camera of the monitor device, capturing the target in high quality within the virtual recognition box. FIG. 9 is a drawing explaining the operation of recognizing each component of the target detected in high quality.

As depicted in FIG. 7, once the virtual recognition box 620 containing the target enters the central guide box 610, the following actions are executed:

At step S5010, the center point (x,y) of the virtual recognition box 610 that includes the entered target object may be extracted.

As depicted in FIG. 6, it is assumed that the coordinates of the top-left corner of the image are (0,0) and the bottom-right corner are (100,000).

At this time, the center point of the acquired virtual recognition box 610 is assumed to be approximately (60,40).

At step S5020, the difference between the center point (x, y) of the virtual recognition box and the center point (Cx, Cy) of the central guide box may be calculated. For example, the center point of the central guide box might be (50,50). It is also possible to use the center point of the screen instead of the central guide box's center point. b. In this case, the difference would be (−10, 10).

At step S5030, based on the calculated difference, the pan tilt adjust mount 400 may be adjusted so that the center point of the virtual recognition box aligns with the center point of the central guide box.

Although this specification mentions adjusting to the center of the screen, this does not limit the invention. For example, it is possible to adjust so that the image of the target object is located at any desired part of the screen, such as the center of the top left.

Based on the calculated difference, adjust the pan tilt adjust mount 400 so that the monitor device 100 can capture the target in the exact center of the screen.

At step S5040, the target is captured in high quality using the second camera, the distance to the target may be measured, and thermal imaging distribution may be performed.

That is, perform the operations described in S4100 of FIG. 4B and subsequent actions.

After capturing the target in high quality with the second camera, analyze the target image to classify and recognize each part included in the target.

As shown in FIG. 8, use the second camera to capture the target in high quality so that it is positioned in the center of the image.

Thereafter, as shown in FIG. 9, classify and recognize each part of the captured target.

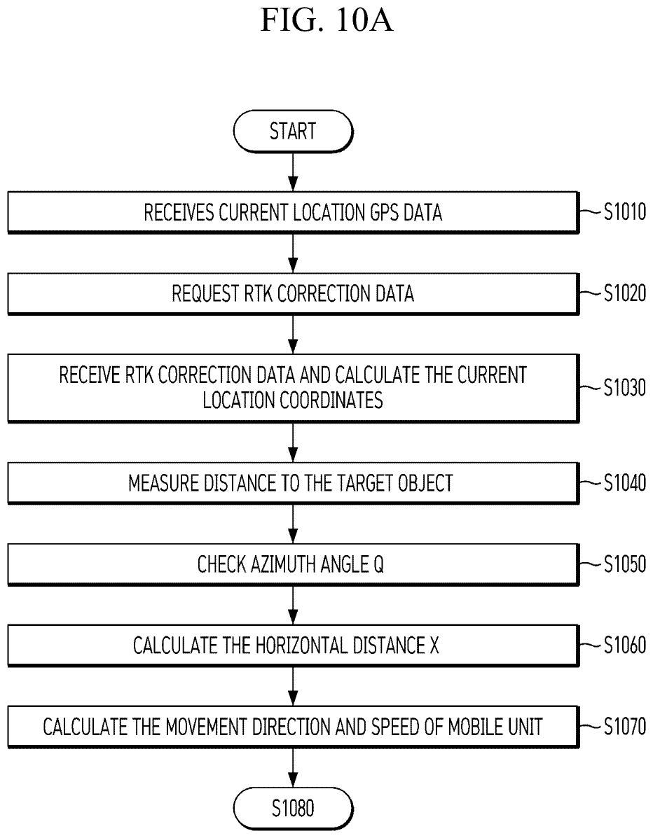

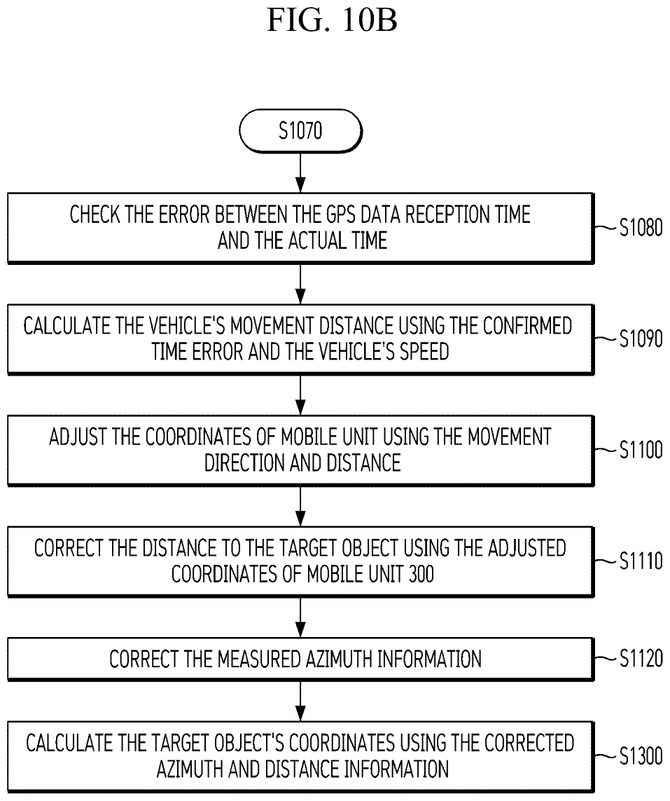

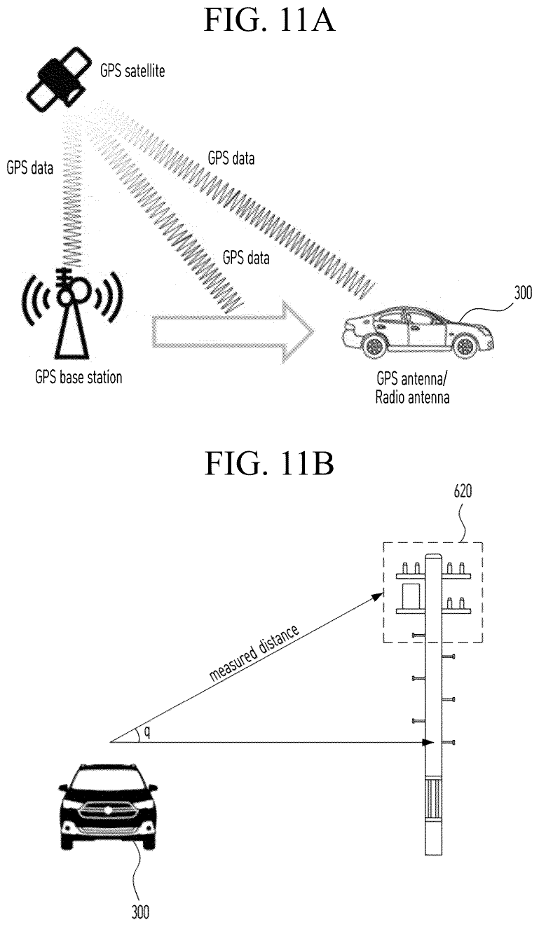

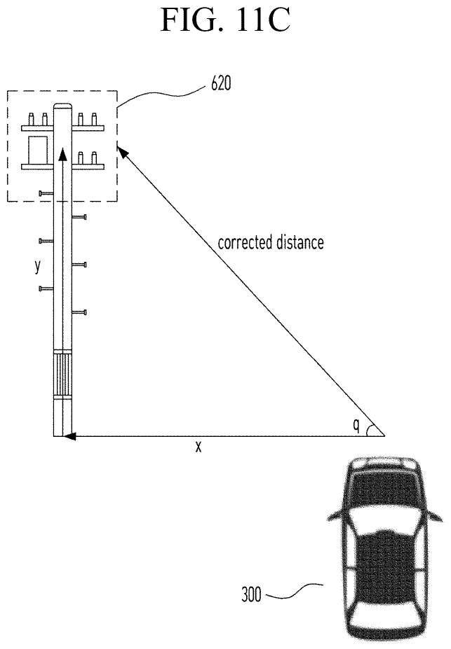

From now on, using FIGS. 10A, 10B, and FIGS. 11A, 11B, 11C, we explain the method for accurately measuring the GPS coordinates of the target object.

FIGS. 10A and 10B are flowcharts related to accurately measuring the GPS coordinates of the target object using GPS signals.

FIGS. 11A, 11B, and 11C are drawings explaining the process of calculating the GPS coordinates.

When the virtual recognition box containing the target enters the central guide box in S4080, the GPS coordinates of the target object are measured as follows.

At step S1010, the monitor device 100 uses the GPS receiver 180 to receive current location GPS data (i.e., from mobile unit 300).

At step S1020, the received GPS data are sent to a predefined RTK base station, and RTK correction data are requested.

The RTK base station is pre-selected, and its information is stored and used by the monitor device.

FIG. 11A explains S1010 and S1020.

At step S1030, the requested RTK correction data may be received and used to calculate the coordinates of the current location (mobile unit).

At step S1040, as shown in FIG. 11B, a laser rangefinder 140 may be used to measure the distance (measured distance) to the target 620.

At step S1050, as shown in FIG. 11B, an azimuth sensor 150 may be used to check the vertical angle q of the monitor device 100.

At step S1060, as shown in FIG. 11C, trigonometry may be used to calculate the horizontal distance x from mobile unit 300 to the target (e.g., utility pole).

At step S1070, GPS data may be used to calculate the direction of movement and speed of mobile unit 300.

At step S1080, the error between the GPS data reception time and the actual time may be determined.

At step S1090, the confirmed time error and the vehicle's speed may be used to calculate the distance the vehicle has moved.

At step S1100: the direction of movement and the distance moved may be used to correct the coordinates of mobile unit 300.

At step S1120, the measured azimuth information may be corrected as follows:

1. Move the monitor device 100 to face the front of the vehicle.

2. Reset the angle of the monitor device 100 to zero.

3. Track the target object's location to check the angle of the monitor device 100.

4. Add the calculated direction of movement of mobile unit 300 to the angle of the monitor device 100 to check its azimuth.

5. Check the error between the azimuth sensor's azimuth and the calculated azimuth information.

6. Correct the azimuth information based on the error.

At step S1130, the corrected azimuth and corrected distance information may be used to calculate the coordinates of the target as follows:

1. Apply trigonometry to the corrected distance and azimuth information.

2. Calculate the x and y-axis distances to the target (e.g., utility pole).

3. Use the corrected coordinates of mobile unit, x-axis distance, and y-axis distance to calculate the coordinates of the target.

This embodiment corrects the coordinates of mobile unit 300 considering the delay in receiving GPS data when moving at high speeds, corrects the distance information to calculate the horizontal distance to the target (e.g., utility pole), and corrects the azimuth based on possible errors that may occur due to the surrounding environment. Thus, using these corrected coordinates, distance, and azimuth information, it is possible to more accurately measure the coordinates of the target.

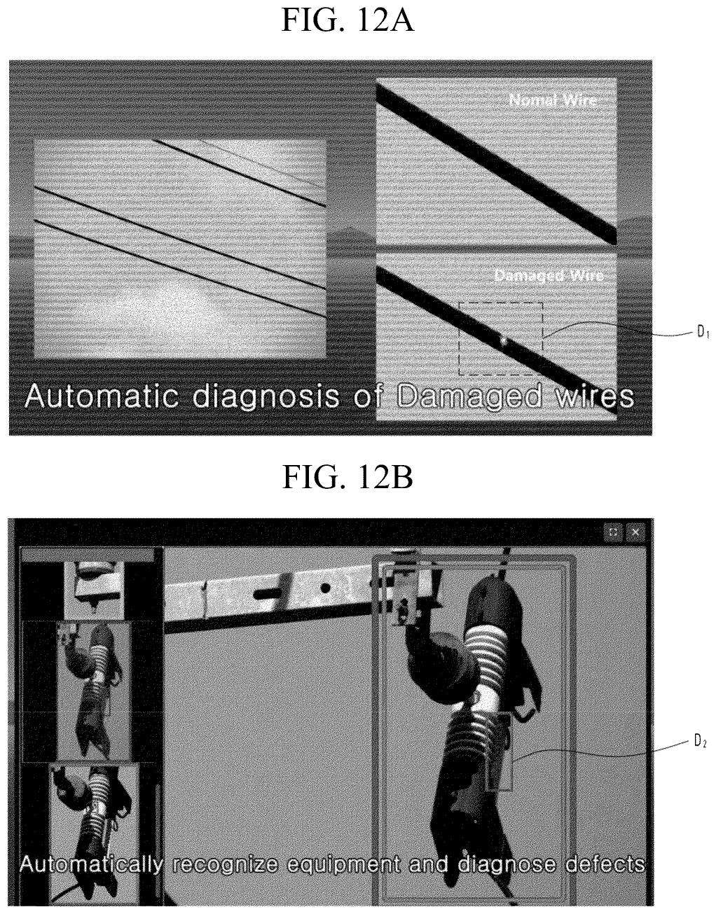

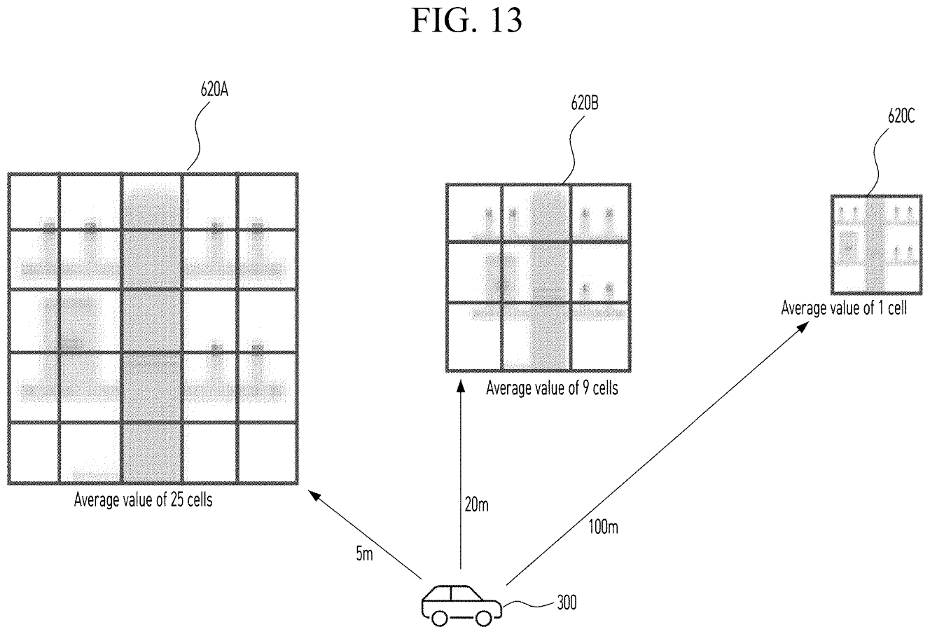

From now on, using FIGS. 12A, 12B, and FIG. 13, the integrated diagnostic operation of step S4120 will be described in more detail.

FIGS. 12A and 12B are drawings explaining how to find defects in the appearance of the target from high-quality images captured of the target.

FIG. 13 is a drawing explaining an example of applying thermal image distribution differently based on distance.

As previously described, this embodiment involves photographing fixed installations and diagnosing the condition of the photographed fixed installations.

The embodiment determines defects by i) inspecting the appearance from real images and ii) analyzing the temperature distribution from thermal images, concluding there is a defect if there are cracks in the appearance or temperatures outside the normal range. In this case, the number of cells in the thermal image distribution is applied differently based on the distance.

In step 4120 of FIG. 4B, the collected data is analyzed to determine if there is a defect in the target.

In this step, the monitor device 100 considers i) high-quality images captured by the second camera, ii) thermal image distribution captured by the thermal camera, iii) distance to the target measured by the laser rangefinder 140, iv) wind speed measured by the wind speed meter 160, and v) driving speed measured by the speed meter 170.

In accordance with an embodiment, high-quality images captured by the second camera 120 can be used. Specifically, the external appearance of the captured target is compared with a model created using AI deep learning technology to determine which part it is, and if any part does not match the normal image of the identified part, it is considered defective. Examples of using external images to determine defects are shown in FIGS. 12A and 12B. FIG. 12A detects part D1 where the coating on a wire's exterior is peeled off, and FIG. 12B detects an abnormal part D2 that is not present in the normal counterpart of the part.

Moreover, if excessive heat is detected in a specific part compared to other parts using the thermal image distribution captured by the thermal camera, it is determined that there is a defect in that part. In accordance with an embodiment, the accuracy of the thermal image distribution shape used at this time is improved by training the captured thermal image shapes using AI deep learning technology, and by automatically applying different numbers of thermal image cells based on distance, wind speed, and driving speed to measure the temperature. For instance, as depicted in FIG. 13, for a target 620A located 5 meters from mobile unit 300, the temperature is measured using the average value of 25 cells; for target 620B located 20 meters away, the temperature is measured using the average value of 9 cells; and for target 620C located 100 meters away, the temperature is measured using the average value of 1 cell.

From now on, the operations executed during S4040 to effectively detect if there is a target object among the searched objects will be described in more detail.

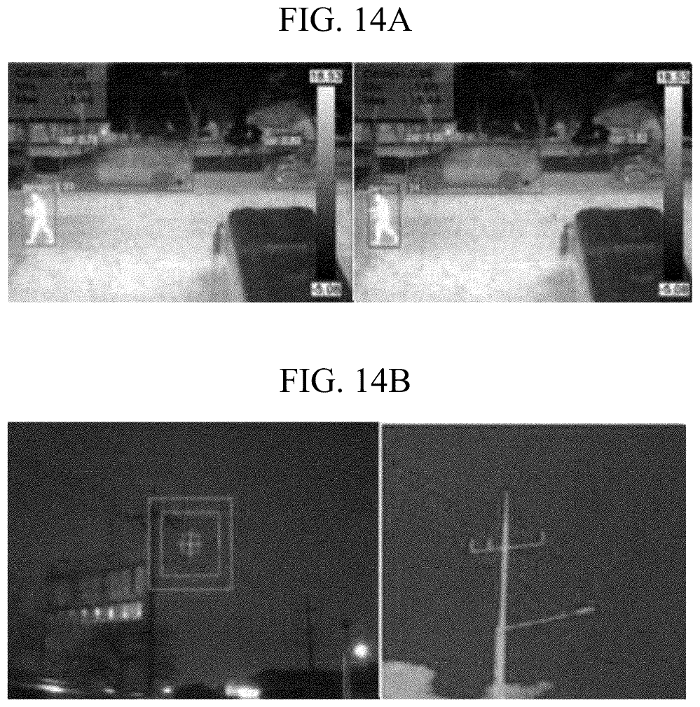

FIGS. 14A and 14B show images captured using a thermal camera. The thermal images clearly display the outlines of objects, enabling the differentiation of the target object. While images captured in dark conditions using the first and second cameras may make it difficult to distinguish the target object, utilizing images captured with the thermal camera facilitates easy identification. In FIG. 14B, the left image is of the target object captured using a standard camera, and the right is the thermal image of the same target object. As seen in FIG. 14B, the target object in the thermal image can be easily discerned.

Therefore, in an embodiment of the invention, real and thermal images are used simultaneously for forward recognition.

a. For example, the shapes of objects appearing in thermal images are modeled using AI deep learning technology, and these modeled shapes are then used for forward recognition, i.e., detecting the target.

b. Images captured with real-image cameras in dark conditions sometimes cannot be used to detect the target.

c. At these times, the thermal images are used to distinguish the shapes of objects, thereby enhancing the target detection capability. For instance, a dataset is implemented and trained to distinguish targets in images captured in thermal view, enhancing forward recognition in low-light conditions at night using thermal imaging.

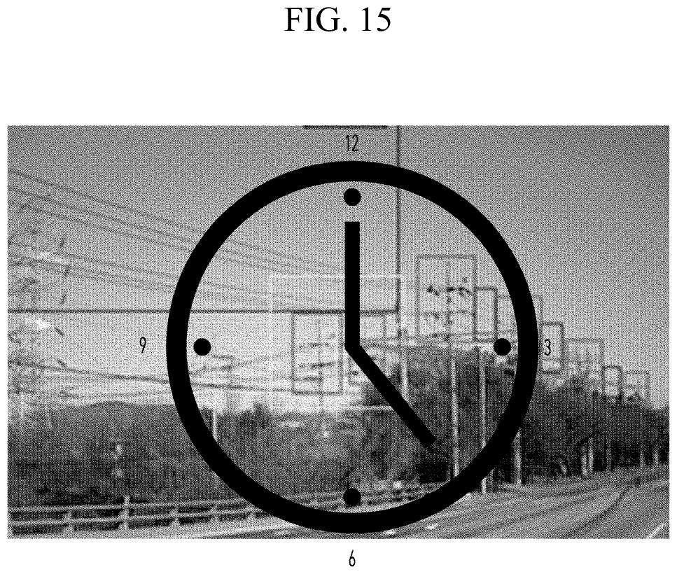

FIG. 15 is a drawing explaining a method for efficiently conducting shooting modes using the sector clock position method. This involves dividing the area in front of the camera into sectors using a virtual clock direction, distinguishing areas where multiple targets are detected, and conducting different shooting actions for each distinguished area.

In an embodiment of the invention, the area in front of the camera is divided into sectors using a clock direction to identify areas where multiple targets are detected, and different shooting actions are performed for each sector. This method utilizes the sector clock position reporting technique as follows.

a. Shooting modes are divided into three types: left shooting mode, right shooting mode, and alley shooting mode.

b. The shooting mode is determined based on the distribution of detected targets. For example, i. If the majority of targets are detected between 7 and 10 o'clock, it is recognized as left shooting mode. ii. If the majority of targets are detected between 12:30 and 3 o'clock, it is recognized as right shooting mode. iii. If the majority of targets are detected between 10:30 and 1:30, it is recognized as alley shooting mode.

c. If recognized as left shooting mode, targets detected in the sector from 1 to 6 o'clock are ignored.

d. If recognized as right shooting mode, targets detected in the sector from 11 to 6 o'clock are ignored.

e. If recognized as alley shooting mode, targets detected in the sector from 3 to 9 o'clock are ignored.

These distinctions in shooting modes and limiting target areas are expected to be very useful when using Drones (UMVs). For example, priorities are set for shooting target areas as follows: a) For instance, the target areas are divided into three zones (Zone 1:10 o'clock to 2 o'clock, Zone 2:3 o'clock to 6 o'clock, Zone 3:6 o'clock to 9 o'clock). b) When starting to shoot, priorities are assigned to each target area (Zone 1: 1st priority; Zone 2: 2nd priority, Zone 3: 3rd priority). c) Shooting actions vary based on priority.

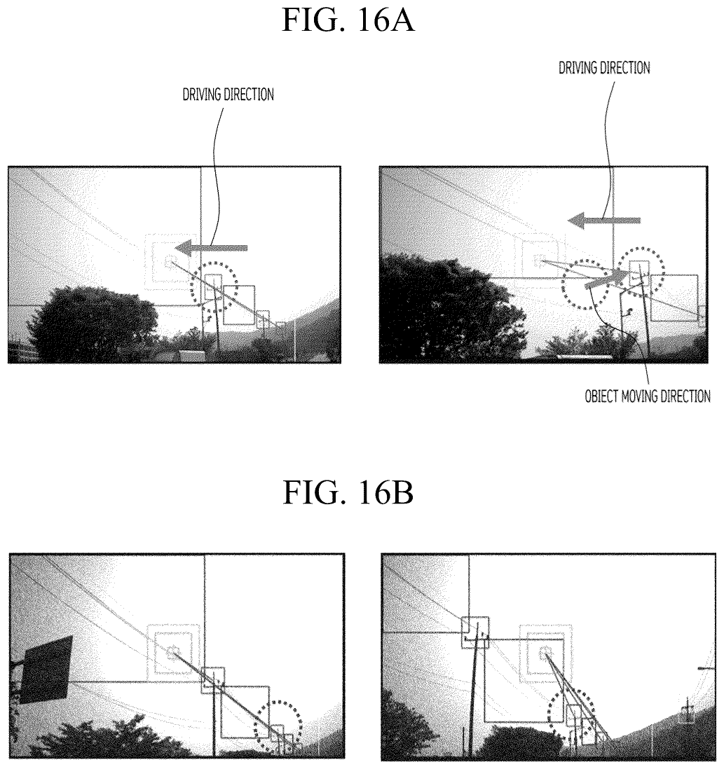

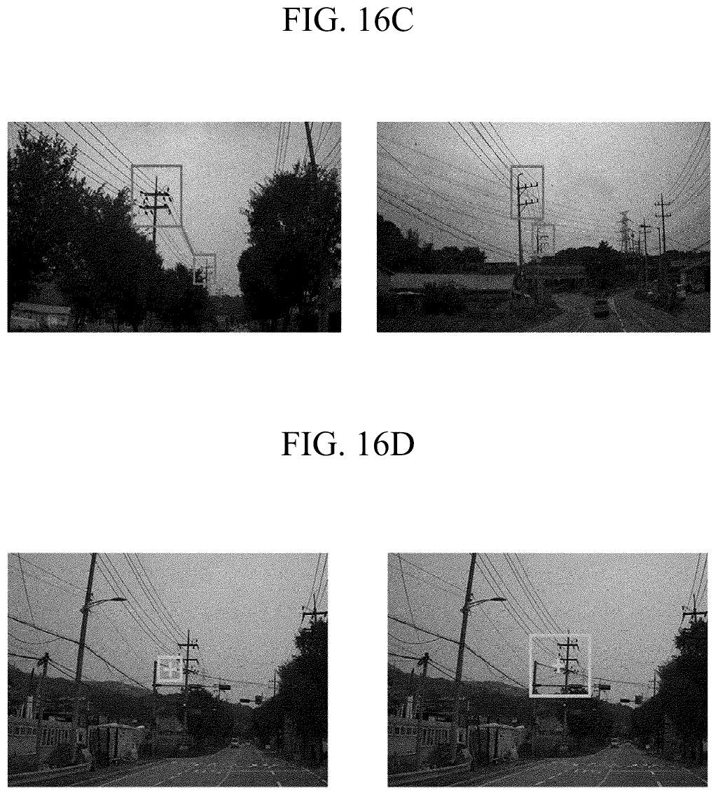

In an embodiment, the following actions are executed to enhance the effectiveness and accuracy of image search and to utilize resources efficiently. These actions are explained using FIGS. 16A, 16B, 16C, and 16D, which illustrate a method for detecting lane changes.

During the operations from S4020 to S4140, continuous detection of changes in the direction of both the mobile unit 300 and the detected targets is conducted. Based on detected changes in direction, actions such as lane changes, exiting the recognition range, or sharp turns are determined and the following actions are executed.

1. Lane changes may be determined as follows.

a. Lane changes are detected through changes in the direction of mobile unit 300 and the detected target's direction. If the directions of mobile unit 300 and the target move oppositely, such as from the second lane to the first lane, it is detected as a lane change. In this case, adjust the pan tilt adjust member 400 to re-center the target in the image whose direction has changed.

b. If the angle between the center point of the guide box and the target recognition box changes abruptly, a lane change (from the first lane to the second or into a curved path) is detected. In this case, adjust the pan tilt adjust member 400 to re-center the target in the image that has undergone a significant angle change.

2. The recognition range may be exited

a. This can occur depending on the location of the target (e.g., a utility pole) and road conditions.

b. In such cases, adjust the size of the central guide box, for example, expanding it by 2 times.

c. After a set period, the size of the central guide box is adjusted back to its normal size.

Additionally, in this embodiment of the invention, to effectively utilize resources in response to sudden changes in the shooting environment, actions like those from S4150 to S4190 are executed to detect stop events, and if a stop event occurs, all actions are temporarily paused, and operations are resumed when a resume event occurs.

For example, by continuously monitoring the azimuth sensor in real-time, if there is a rapid change in azimuth, such as turning left/right or making a U-turn, this is detected as a stop event (S4150). Then, all actions are temporarily paused (S4170). Operations resume upon a resume event or after a set time (S4180).

For instance, if the azimuth sensor changes by more than 5 degrees, it is determined that a stop event has occurred, and operations are temporarily paused. If the azimuth sensor maintains a change of less than 5 degrees for about 5 seconds, operations restart.

Alternatively, if the speed of mobile unit 300 continuously monitored falls below a certain speed (e.g., 2 km/h) for a set duration (e.g., 10 seconds), it is determined that a stop event has occurred and operations are temporarily paused. Once the speed exceeds a certain threshold for a set duration, it is considered that a resume event has occurred, and the paused operations are resumed. This allows for efficient use of memory space.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The present disclosure can be embodied in the form of methods and apparatuses for practicing those methods. The present disclosure can also be embodied in the form of program code embodied in tangible media, non-transitory media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present disclosure can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present disclosure can also be embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard and would be recognized by other elements as sufficiently capable of communicating with the other elements in the manner specified by the standard. The compatible element does not need to operate internally in a manner specified by the standard.

No claim element herein is to be construed under the provisions of 35 U.S.C. § 112, sixth paragraph, unless the element is expressly recited using the phrase “means for” or “step for.”

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of dynamically recognizing and diagnosing defects in stationary objects using a monitor device while traveling using a mobile unit, where the monitor device is mounted on the mobile unit through a pan tilt adjust mount, the method comprising:
continuously capturing images of a predetermined area using a first camera included in the monitor unit;
detecting a target stationary object to diagnose among objects in the captured image;
capturing a high-quality image and a thermal image of the detected target stationary object using a second camera and a thermal camera included in the monitor unit;
determining whether the detected target stationary object has defects based on the high-quality image and the thermal image; and
transmitting a result of determination to a predetermined device.

2. The method of claim 1, wherein the determining comprises:
comparing an outer appearance of the high-quality image of the detected target stationary object with related reference models built through a predetermined artificial intellectual deep learning machine; and
calculating a mean temperature of the detected target stationary object based on a predetermined number of cells of the captured thermal image.

3. The method of claim 2, wherein the predetermined number of cells is determined based on a distance measured by a laser rangefinder included in the monitor device from the monitor device to the detected target stationary object.

4. The method of claim 1, wherein the continuously capturing images of a predetermined area comprises:
continuously capturing thermal images of the predetermined area using a thermal camera included in the monitor device; and
detecting objects in the captured image using the images captured by the first camera and thermal images captured by the thermal camera.

5. The method of claim 4, wherein out appearances of objects in the thermal images are used to detect the objects.

6. The method of claim 1, further comprising, after the detecting a target stationary object to diagnose among objects in the captured image:
controlling the pan tilt adjust mount to position the monitor device to capture images of the target stationary object to be a center of an image.

7. The method of claim 6, wherein the controlling comprises:
forming a virtual guide box at a center of an image;
forming a virtual recognition box to include each target stationary object;
when the virtual recognition box enters the virtual guide box, performing the controlling the pan tilt adjust mount.
